(19) United States
(12) Patent Application Publication
(10) Pub. No.: US 2005/0110771 A1
(43) Pub. Date: May 26, 2005

(54) Three dimensional position sensing apparatus and method for a display device

(76) Inventors: Bernard J. Hall, Elizabeth, NJ (US); Francois B. Kapp, Kommetjie (ZA)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 10/995,783

(22) Filed: Nov. 22, 2004

Related U.S. Application Data
(60) Provisional application No. 60/524,170, filed on Nov. 21, 2003.

(51) Int. Cl. G09G 5/00

(52) U.S. Cl. 345/173

(57) ABSTRACT

A position sensing device for a display device includes an oscillator, a first and second electrode pair, a transparent conductive layer positioned on a display of the display device, first and second differential amplifiers, an amplifier and a processor. The first differential amplifier provides a first signal indicative of distance of the first electrode pair from the second body part of the operator in an x-direction. The output of the second differential amplifier provides a second signal indicative of distance of the second electrode pair from the second body part of the operator in a y-direction. The output of the amplifier provides a third signal indicative of distance of the transparent conductive layer from the second body part of the operator in a z-direction. The processor is operable to generate a three dimensional distance signal based on the output of the differential amplifiers and amplifier.

### CROSS REFERENCE TO RELATED APPLICATIONS

This application claims priority under 35 U.S.C. §119 (e) to U.S. provisional patent application No. 60/524,170, filed Nov. 21, 2003, which is hereby incorporated by reference.

### FIELD OF THE INVENTION

The present invention relates to an input device and more particularly a three dimensional position sensing device for a display device.

### BACKGROUND OF THE INVENTION

Computer systems today utilize many different tools to allow an operator to interface with a computer. For instance, a cursor controlled by a mouse or the like has become a necessary tool of the modern computer system. The cursor allows the operator to both operate the movement of an on-screen cursor and execute commands. It is therefore an important objective of the information industry to develop a faster and more efficient method of controlling operations of the computer system.

The typical and commonly used tool is a keyboard and a mouse to interact with a computer. However, typical input devices use only two dimensions (in x and y direction). For flexibility and for certain applications such as a bank ATM or mobile telephone display, it is desirable to provide an input device with a third dimension (z-direction) input capability such that the position of a user's finger can be detected in three dimension. More specifically, there is a need for a three dimensional position sensing apparatus to operate and control symbols displayed on a display screen.

### SUMMARY OF THE DISCLOSURE

According to the invention there is provided a position sensing device for a display device. An oscillator provides an oscillating injection signal for coupling to a first body part of an operator. As a result, an electrical field is generated about a second body part of the operator. A first electrode pair is arranged on one side of the display device and a second electrode pair is arranged on another side of the display device. A thin transparent conductive layer is positioned on a display of the display device. A first differential amplifier having first and second differential inputs is connected to the first electrode pair. The output of the first differential amplifier provides a first signal indicative of distance of the first electrode pair from the second body part of the operator in an X-direction. A second differential amplifier is provided having a first and second differential inputs connected to the second electrode pair. The output of the second differential amplifier provides a second signal indicative of distance of the second electrode pair from the second body part of the operator in a y-direction. An amplifier is also provided having an input connected to the thin transparent conductive layer. The output of the amplifier provides a third signal indicative of distance of the transparent conductive layer from the second body part of the operator in a z-direction. A processor is connected to the first and second differential amplifiers and the amplifier. The processor is also operable to generate a three dimensional distance signal.

### BRIEF DESCRIPTION OF THE DRAWINGS

A better understanding of the present invention can be obtained when the following detailed description of the preferred embodiment is considered in conjunction with the following drawings, in which:

FIG. 1 is an exemplary schematic block diagram of a position sensing system in the present invention.

FIG. 2 is a display device illustrating the positioning of the electrodes with the respect to the display screen.

FIG. 3 is a illustration of the display device and the arrangement of the electrodes.

FIG. 4 is graph illustrating the signal strength on the sensors with respect it to the Distance.

### DETAILED DESCRIPTION OF THE INVENTION

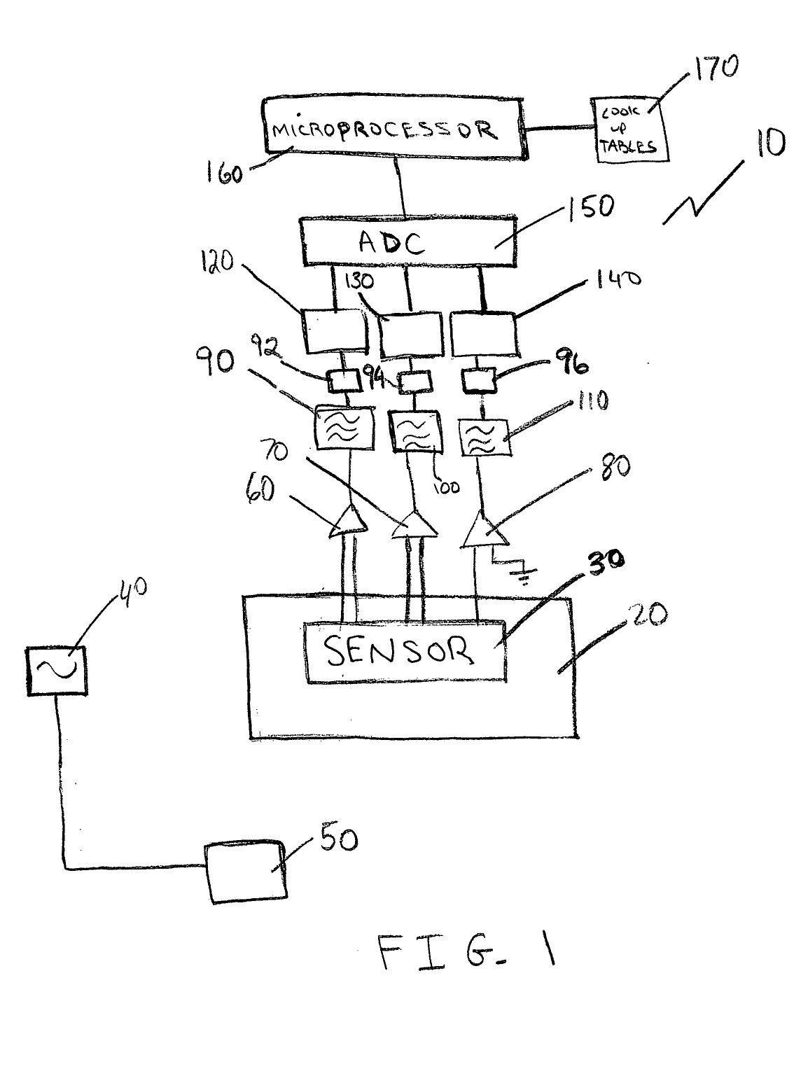

Referring first to FIG. 1, reference numeral 10 generally designates a three dimensional position sensing system comprising an insulating board 20 with a sensor 30 positioned on the insulating board. The insulating board may be part of a display device containing a display screen. An oscillator 40 is connected to an injection pad 50. The oscillator 40 generates an oscillating signal which is transmitted to the injection pad 50. A body part of an operator is connected to the oscillator through contact with the injection pad 50.

The oscillator pad 50 is arranged so that a different movable body part can act as a radiating antenna. The movable body part may be one of the hands of the operator. Where the movable body part is a hand (finger tip) of the operator, the field may be established by injecting an electrical signal into the operator body's part through the injection pad 50. The strength of the field may be sensed by electrodes that are arranged near the display screen.

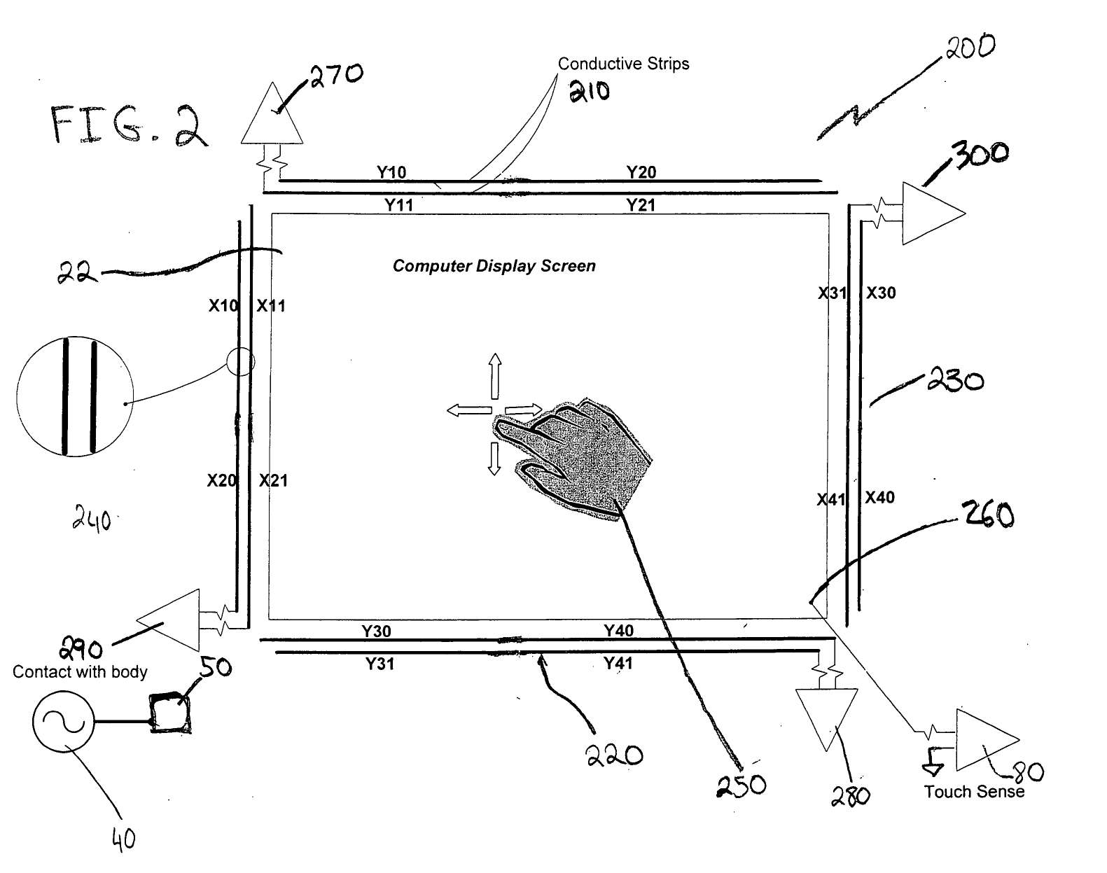

The sensor 30 consists of a series of electrodes positioned upon the insulating board 20. The arrangement of the sensors will be discussed in further detail with reference to FIG. 2. When an oscillating signal is applied to the operator through the injection pad 50 and the operator generates a coupling effect with the electrodes positioned on the display device through movement of the finger tip over the display, an electric field is created between the finger tip and the electrodes which can be measured. The operating principles for the creation of an electric field between the pointing object (finger tip) and the sensing electrodes are disclosed in International Application Number PCB/IB2002/002494, entitled “Apparatus for Sensing the Position of a Pointing Object”, published on Jan. 16, 2003, which is incorporated herein by reference.

Differential amplifiers 60, 70, and 80 are connected to the outputs of the electrodes corresponding to the x-axis, y-axis and z-axis data, respectively. The outputs from the differential amplifiers 60, 70, and 80 are then inputted into band-pass filters 90, 100, and 110, and then into linearizers 92-96 and then synchronous demodulators/detectors 120, 130 and 140.

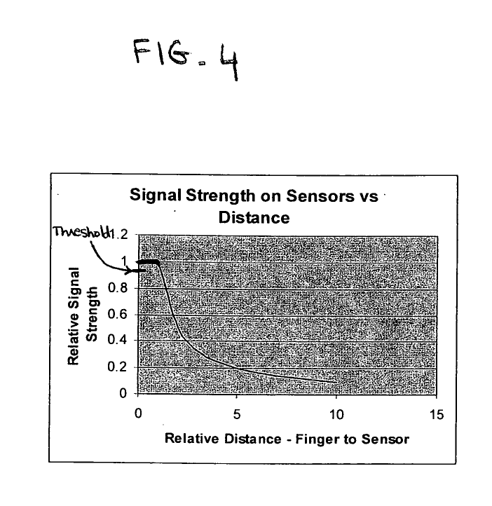

The linearizers convert a nonlinear response (such as y=1/x, see FIG. 4) of the sensor signals as a function of distance to a linear output.

The synchronous detector/demodulator is a demodulator that runs at the same frequency as the input frequency. The simplest form of this is a rectifier. In the embodiment shown, since the oscillating frequency is known, the synchronous demodulator uses a switch that switches from positive to negative at the zero crossings in the input signal. The output for a sinusoidal input signal is simply a rectified sinusoidal. This effectively performs a demodulation on the signal—transferring the useful information (amplitude in the present case) from a high frequency down to DC. The high oscillating frequency signal is useful for two reasons: 1. it allows the signal to propagate through the capacitive coupling of the sensing elements; and 2. it allows the input amplifiers to operate in a relatively noise free frequency band. Thus, the synchronous demodulator enables easy determination of the signal amplitude by a standard analog to digital converter.

The x-axis data is received by the differential amplifier 60 and then fed via a band-pass filter 90 and a synchronous demodulator 110 to a first input of an analog-to-digital converter (ADC) 150. Electrodes corresponding to y-axis data are connected to the two inputs, respectively, via a difference amplifier 70. The output from the difference amplifier 70 is connected via a band-pass filter 100 and a synchronous demodulator 130 to a second input of the analog-to digital converter 150. Electrodes corresponding to the z-axis data are connected to a differential amplifier 80 in which one input is grounded so as to act as a simple amplifier. The output from the differential amplifier 80 is then transmitted to the analog-to-digital converter (ADC) 150 via the band-pass filter 110 and synchronous demodulator 140.

The band-pass filters 90, 100 and 110 each have a centre frequency which corresponds to the frequency of the oscillator 40. The three-dimensional position sensing system 10 also comprises a microprocessor 160. The output of the analog-to-digital converter 150 is connected to an input of the microprocessor 160. It should be noted that other inputs such a PDA or mouse may also be connected to the microprocessor 160. Subsequently, a look-up table 170 is utilized to convert the voltage signal received from the sensor to distance values. The distance values are then manipulated by the microprocessor 160 to control and operate the cursor or other displayed symbols on the display screen.

Now referring to FIG. 2, a more detailed description of a display device incorporating the system described above is illustrated. A thin conductive layer 22 on top of a display (display screen) of a display device 200. In one form, the conductive layer can be a think transparent conductive film such as Orgacon™ film from Agfa Corporation. In another form, the conductive layer can be an ink or coating that can be applied on top of the display such as Eikos™ transparent conductive ink available from Eikos Corporation.

On the plastic cover portion of the display device 200, there are two pairs of spaced position-sensing electrodes 210, 220, 230, and 240, namely a first pair of parallel electrodes 210, 220 and a second pair of parallel electrodes 230 and 240. The electrodes 210 and 220, positioned at the bottom and top of the display, extend in an X axis direction, i.e., along the length of the monitor, and, as will be explained in more detail hereinafter, are thus able to detect the position of the operator's finger 250 in the Y axis direction. The electrodes 230 and 240, positioned at the right and left side of the display, extend in the Y axis direction, i.e., in a direction perpendicular to the X axis direction, and are thus able to detect the position of the operator's hand 250 in the X axis direction.

Also, the injection pad 50 is so arranged that an injection signal from the oscillator 40 is provided to the operator through physical contact with the pad. An electrode 260 in addition to the electrode pairs 210, 220, 230 and 240 is also provided so that the position of the operator's finger in a third or Z axis direction, perpendicular to the X-Y plane, can also be determined.

The electrodes 210 and 220 are coupled to the two inputs, respectively, of differential amplifiers 270 and 280. The output for the differential amplifiers 270 and 280 provide the input to the differential amplifiers 60 as illustrated in FIG. 1. Likewise, electrodes 230 and 240 are connected to the two inputs, respectively, of a difference amplifier 70, each via differential amplifiers 280 and 290.

The thin transparent conductive coating 22 on the surface of the display is connected to an amplifier 80 (differential amplifier with one input grounded to act as a simple amplifier). As mentioned above, the oscillating signal received by an operator 250 via an injection pad 50 couples to each of the electrodes and to the conductive layer 22, thereby generating an electric field on the display device in the X, Y and Z directions. It should be noted that the amount of coupling is a function of the distance of the finger to the conductive electrodes and the thin conductive layer 22. The output signals from the five amplifiers in FIG. 2 can be used to determine the position of the finger in three dimensions by using the signals obtained from the electrodes 230, 240 for x-position, the signals obtained from the electrodes 210, 220 as the Y-position and the signal obtained from the thin transparent conductive layer as the Z-position.

The electrodes are able to detect the strength (i.e., amplitude) of this field and, from this determine the position of the operator's hand in the X, Y and Z axis directions. This is done in conjunction with the difference amplifiers 60, 70, 80 and the synchronous demodulators 120, 130 and 140 which remove the frequency component of the oscillating signal as discussed above. Any extraneous signals are filtered out by the band-pass filters 90, 100, 110 and the synchronous demodulators 120, 130, and 140 provide analog outputs corresponding to the position of the operator's hand, respectively, the X, Y and Z axis directions. The three analog signals are fed to the analog-to-digital converter 150 which converts the three signals to a digital form. The microprocessor 160 serves to convert the signal into a suitable data bit-stream. The protocol of the bit-stream may be such as to emulate a standard mouse protocol required by a conventional software mouse driver resident in the PC. The bit-stream is fed to a look up table or the like, and is interpreted by the computer as if it was reading data sent by a conventional mouse during normal mouse operation. The information contained in the bit-stream could also be transmitted to the PC via an existing data link between display device and the PC, using suitable software.

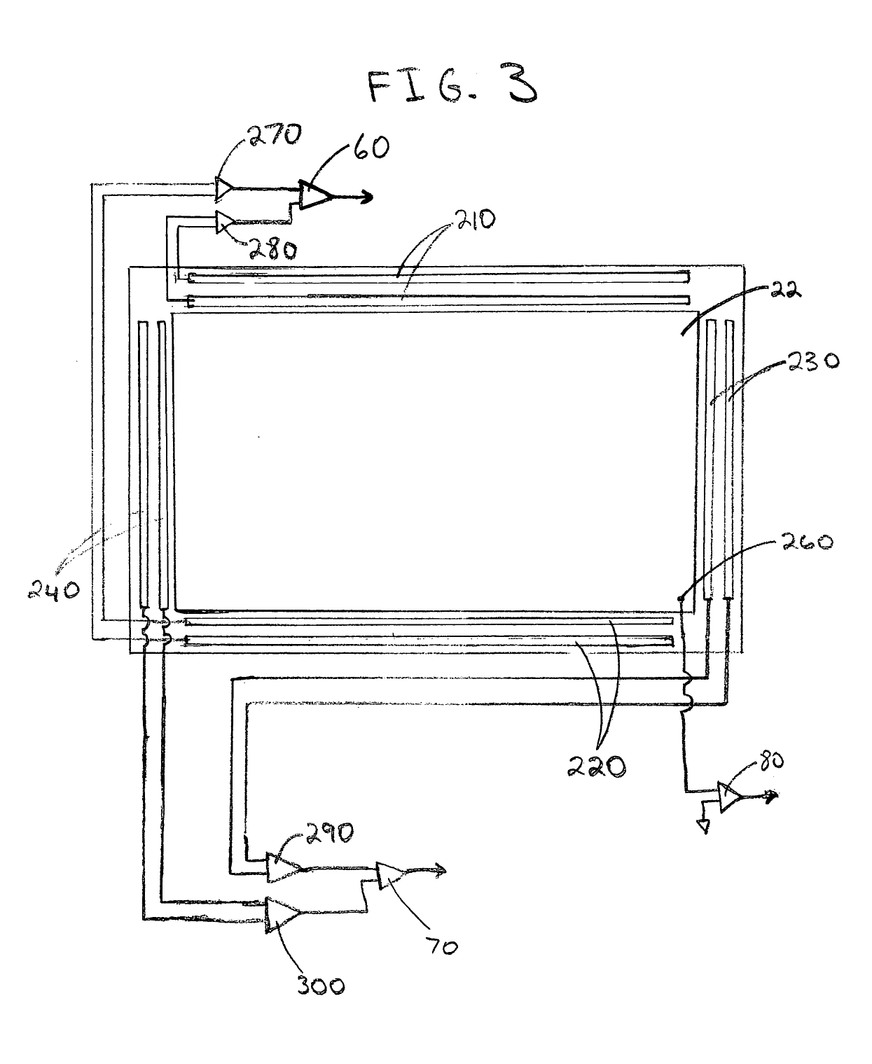

Now turning to FIG. 3, a more detailed description of the present invention is described. An electrical signal generated by the oscillator 40 is injected via the signal injection electrode 50 into the operator's body. The injection may be effected by conduction, in which event physical contact with the electrode 50 will be required, or it may be effected by means of capacitive, electromagnetic, or radiation induction, in which event physical contact with the electrode 50 is not required. The injected signal creates an alternating electric field around the operator's body, including, via conduction through the operator's body.

The electrodes 260, 270, 280, 290, and 300 are able to detect the strength (i.e. amplitude) of this field and, from this determine the position of the operator's hand in the X, Y and Z axis directions. This is done in conjunction with the difference amplifiers 60, 70, and 80. More specifically, the output from electrode 210 corresponding to the X co-ordinate direction is transmitted to differential amplifier 270. Likewise, the output from electrode 220 is fed into differential amplifier 280. The outputs from amplifiers 270 and 280 are then fed into another differential amplifier 60.

Similarly, the outputs from the electrodes 230, 240 are inputted into differential amplifiers 290 and 300. The output from amplifiers 290, 300 is then received by another differential amplifier 70. Finally, the output data gathered from the Z direction at electrode 260 is transmitted into differential amplifier 80 which is acting as a simple amplifier with one input grounded (reference potential). The outputs from the differential amplifiers 60, 70, and 80 are then inputted into the Analog-to-Digital converter via the band-pass filters 90, 100, 110, linearizers 92-96 and the synchronous demodulators 120, 130, and 140.

FIG. 4 illustrates a graph showing the nonlinear signal strength on the sensor at any one of the outputs of synchronous demodulators 120-140 versus the distance. Thus, when the operators hand or finger passes over the display device the electric field is disturbed and signals are transmitted to the corresponding electrodes. As result, as the finger of the operator gets further away from the sensor the strength of the signal weakens as illustrated in FIG. 5. In the embodiment shown, the conductive layer 22 is sufficiently sensitive to accurately measure the z-distance which is generally equivalent to the length or height of the display. Thus, if the x-distance (length) of the display is 15 inches, then the conductive layer 22 is sensitive enough to accurately measure the vertical distance of up to 15 inches.

In one useful application, the output of the conductive layer 22 is used to detect selection (by touching of the display or otherwise bringing the finger tip very closely to the display surface) of a displayed symbol by monitoring the output of the detector 80 or more practically the output of the synchronous demodulator 140. For example, as shown in FIG. 4, the relative output as the finger tip comes closer to the display rises to a maximum saturation value of 1. Accordingly, detection of touch can be determined by monitoring to see whether the output rises above a threshold value such as 0.9. Once the touch is detected, the x and y value of the finger tip's position can be used to select a displayed symbol or button that is closest to the detected x-y position of the finger tip.

Also, the system 10 is provided with an auto calibration button which can be connected to an input of the microprocessor 160. It will be understood that the auto calibration button could also be in the form of a touch pad. When the auto calibration button is activated by the operator, the microprocessor will perform a calibration function, correlating the position of the operator's hand and the cursor position on the display screen. This is possible because the operator's hand, when activating the calibration button will of necessity be in a known position in the X-Y plane.

The foregoing disclosure and description of the disclosed embodiments are illustrative and explanatory thereof, but to the extent foreseeable, the spirit and scope of the invention are defined by the appended claims.

1. A position sensing device for a display of a display device, comprising:
an oscillator that generates an oscillating injection signal for coupling to a first body part of an operator and generating an electrical field about a second body part of the operator;
a first electrode pair arranged on one side of the display device;
a second electrode pair arranged on another side of the display device;
a transparent conductive layer positioned on a display of the display device;
a first differential amplifier having first and second differential inputs connected to the first electrode pair, and an output providing a first signal indicative of distance of the first electrode pair from the second body part of the operator in an x-direction;
a second differential amplifier having first and second differential inputs connected to the second electrode pair, and having an output providing a second signal indicative of distance of the second electrode pair from the second body part of the operator in a y-direction; and
an amplifier having an input connected to the transparent conductive layer, the output of the amplifier providing a third signal indicative of distance of the transparent conductive layer from the second body part of the operator in a z-direction.

2. The position sensing device according to claim 1, further comprising a synchronous demodulator having an input connected to the amplifier to remove the frequency component of the oscillating signal.

3. The position sensing device according to claim 2, further comprising a processor operable to determine selection by the operator of a symbol displayed on the display based on the output of the synchronous demodulator.

4. The position sensing device according to claim 3, wherein the processor determines the selection by detecting whether the output of the synchronous demodulator is above a threshold value.

5. The position sensing device according to claim 2, further comprising a linearizer connected to the output of the amplifier to linearize a nonlinear signal as a function of distance coming from the transparent conductive layer.

6. The position sensing device according to claim 1, further comprising a processor operable to determine selection by the operator of a symbol displayed on the display based on the output of the transparent conductive layer.

7. The position sensing device according to claim 6, wherein the processor determines the selection by detecting whether the output of the amplifier is above a threshold value.

8. The position sensing device according to claim 1, further comprising:
a third electrode pair are positioned on the other side of the first electrode pair.
a third differential amplifier having first and second differential inputs connected to the third pair;
fourth differential amplifier having first and second differential inputs respectively connected to the output of the first differential amplifier and the output of the third differential amplifier.

9. The position sensing device according to claim 1, wherein the transparent conductive layer is a transparent conductive coating on the display.

10. The position sensing device according to claim 1, wherein the transparent conductive layer is a transparent thin conductive film.

11. A position sensing device for a display of a display device, comprising:
an oscillator that generates an oscillating injection signal for coupling to a first body part of an operator and generating an electrical field about a second body part of the operator;
a transparent conductive layer positioned on a display of the display device;
an amplifier having an input connected to the transparent conductive layer, the output of the amplifier providing a signal indicative of distance of the transparent conductive layer from the second body part of the operator in a z-direction.

12. A method for sensing and controlling a cursor on a display device comprising the steps of:
generating an oscillating injection signal for coupling to a first body part of an operator which generates an electrical field about a second body part of an operator;
receiving a signal from a transparent conductive layer positioned on a display of the display device, the signal indicative of distance of the transparent conductive layer from the second body part of the operator in a z-direction; and
amplifying the signal; and
processing the amplified signal to generate a z-direction position signal.
